(19) United States
(12) Patent Application Publication
(10) Pub. No.: US 2015/0247108 A1
(43) Pub. Date: Sep. 3, 2015

(54) DETERGENT

(71) Applicant: The Procter & Gamble Company, Cincinnati, OH (US)

(72) Inventors: Jean-Luc Philippe BETTIOL, Etterbeek (BE); Jef Annie Alfons MAES, Sint-Niklaas (BE); Robby Renilde Francois KEULEERS, Lippelo (BE)

(21) Appl. No.: 14/612,475

(22) Filed: Feb. 3, 2015

(30) Foreign Application Priority Data
Feb. 28, 2014 (EP) 14157264.4

(51) Int. Cl. C11D 3/00; C11D 3/20; C11D 3/37

(52) U.S. Cl. CPC C11D 3/0089; C11D 3/3749; C11D 3/3765; C11D 3/201

(57) ABSTRACT

A liquid detergent aqueous composition comprising a mono-alcohol and an opacifier wherein the opacifier has improved stability in ethanol versus Acusol 301 and wherein the opacifier preferably is a high order polymer.

### FIELD OF THE INVENTION

The present invention is in the field of detergents. In particular, it relates to a liquid detergent, more in particular to an aqueous liquid detergent comprising a mono-alcohol and an opacifier. The invention also relates to a process for making a premix and a process for making a liquid detergent using the premix. The detergent is aesthetically pleasant and presents good stability. The process entitles easiness of manufacture and versatility.

### BACKGROUND OF THE INVENTION

Some consumers find aesthetically pleasant opaque liquid detergents. Opaque products seem to connote quality and sophistication. This appearance can be achieved by the use of opacifiers. Opacifiers are usually suspensions of submicron size particles that modify the appearance of liquids through mainly light scattering. The level of opacifier necessary to confer this pleasant aesthetics to a liquid detergent is not very high.

It can be very difficult to handle an opacifier during manufacture because the particles can be prone to flocculation, sedimentation or any other type of separation. It is also difficult to keep the particles of the opacifier suspended during the life of a liquid detergent.

Opacifiers can be susceptible to microbial growth. In order to store an opacifier in a manufacturing environment a preservative needs to be added. Mono-alcohols are usually added as preservatives to pre-mixes containing an opacifier. A problem might occur when mixing is not totally homogeneous and local pockets of mono-alcohol are formed. In these cases the mono-alcohol, that usually has good solvency properties, can negatively impact the stability of the suspension. Thus good mixing is needed in the process of manufacture in order to avoid these local pockets of mono-alcohol. This sometimes can impose too strenuous manufacturing limitations, such a long mixing times resulting in manufacturing capacity reduction, they also need more energy for mixing, etc. It has been surprisingly found that with the opacifier of the invention, this problem can be ameliorated and it can even be avoided, thereby providing manufacture flexibility.

The objective of the present invention is to provide a detergent with an opaque appearance that is physically stable under storage and transport and a process for making the product. The process should be flexible and versatile.

### SUMMARY OF THE INVENTION

According to the first aspect of the invention, there is provided a liquid detergent composition. The composition is aqueous. By “aqueous” is herein meant that the composition comprises more than 15%, preferably more than 20% and more preferably more than 30% by weight of the composition of water.

The composition comprises a mono-alcohol and an opacifier. By “mono-alcohol” is herein meant a hydrocarbon comprising only one —OH group.

According to the first aspect, the opacifier has improved stability in ethanol. By “improved stability” is herein meant that under the same conditions the opacifier of the invention is stable, preferably physically stabile, in a water-ethanol solution comprising a higher level of ethanol than the same solution comprising Acusol 301. Stability is evaluated by visual observation. By “stable” is herein meant that when the solution is observed with the naked eye no separation of the particles can be seen. In particular for the purpose of this invention an opacifier is considered to be more stable than Acusol 301 if the opacifier is stable in a water-ethanol mixture comprising 10% by weight of the mixture of opacifier and more than 50% of ethanol.

Acusol OP 301, herein shortened as Acusol 301, is an opacifier supplied by Dow. Acusol 301 is provided as an aqueous polymeric dispersion comprising 40% polymeric particles by weight of the dispersion. The polymer is synthesized from styrene and acrylate comonomers and is made through emulsion polymerization. The polymer is present in the dispersion in particulate form.

“Polymer,” as used herein and as defined by F W Billmeyer, JR. in Textbook of Polymer Science, second edition, 1971, is a relatively large molecule made up of the reaction products of smaller chemical repeat units. Normally, polymers have 11 or more repeat units. Polymers may have structures that are linear, branched, star shaped, looped, hyperbranched, crosslinked, or a combination thereof; polymers may have a single type of repeat unit or they may have more than one type of repeat unit. Polymers may have the various types of repeat units arranged randomly, in sequence, in blocks, in other arrangements, or in any mixture or combination thereof. Chemicals that react with each other to form the repeat units of a polymer are known herein as “monomers” and a polymer is said herein to be made of “polymerized units” of the monomers that reacted to form the repeat units.

Preferably the opacifier of the invention is a polymer and more preferably a high order polymer. By “high order polymer” is meant a polymer that is made from more than two monomers, preferably three or more. According to the second aspect of the invention, the polymer is a high order polymer.

Preferably, the opacifier of the invention is a polymer comprising monomers comprising styrene. More preferably, the opacifier further comprises monomers comprising units selected from the group consisting of carboxylates including acrylate, maleate and methacrylate; carboxylic amides including acrylamide; alkenyl; alkoxy; polyalkoxy and mixtures thereof. Preferred carboxylate include acrylate and maleate.

Especially preferred for use herein is a polymer comprising styrene, acrylate and monomers comprising maleate. In particular a styrene-polyethylene glycol-10 maleate-acrylate or a styrene/polyethylene glycol-10 maleate/nonoxanol-10 maleate/acrylate copolymer.

Preferably the composition of the invention comprises from about 0.001% to about 3%, more preferably from about 0.005% to about 2% and especially from about 0.05% to about 1.5% by weight of the composition of opacifier. This level of opacifier seems to be optimum to provide the liquid detergent very appealing appearance.

The liquid detergent of the invention comprises a mono-alcohol; the primary function of the mono-alcohol is to act as anti-microbial active. Preferably, the mono-alcohol has Hansen polarity parameter of from about 5 to about 15 (Mpa)^{1/2} and a Hansen hydrogen bonding parameter of from about 15 to about 25 (Mpa)^{1/2}. Best performing alcohols have been found to be those selected from the group consisting of C1 to C3 alcohols and mixtures thereof, most preferred for use herein being ethanol.

Especially preferred for use herein, in terms of appearance and stability, are compositions wherein the polymer is a styrene-polyethylene glycol-10 maleate-acrylate or a styrene/polyethylene glycol-10 maleate/nonoxanol-10 maleate/acrylate copolymer and the mono-alcohol is ethanol.

According to a third aspect of the invention, there is provided a process for making a premix.

The process comprises the step of mixing water, a mono-alcohol and an opacifier wherein the opacifier has improved stability in ethanol versus Acusol 301 and wherein the opacifier preferably is a high order polymer. The mixing step does not need to achieve perfect mixing, even if some pockets of mono-alcohol are formed, the opacifier is robust enough not to become instable. This presents a great advantage from the manufacture feasibility view point, reduce the mixing time and energy required.

A “premix” for the purpose of this invention is the combination of a plurality of ingredients prior to its addition to subsequent ingredients to form the finish product.

Preferably, the opacifier used to make the premix is in the form of an aqueous dispersion with a solid content of from about 10 to about 50% by weight of the dispersion. Preferably, the level of opacifier in the premix is from 2% to 20% by weight thereof. Preferably, the level of mono-alcohol is below 20%, more preferably from 15% to 1%, and especially from 12% to 5% by weight of the premix. When given the level of opacifier in the present invention, it meant the level of polymer particles.

Especially preferred premixes comprise a styrene-polyethylene glycol-10 maleate-acrylate or a styrene/polyethylene glycol-10 maleate/nonoxanol-10 maleate/acrylate copolymer as opacifier and ethanol as mono-alcohol. This premix has been found to be very stable.

According to another aspect of the invention, there is provided a process for making a liquid detergent composition comprising the steps of adding the premix of the invention to a detergent base.

The features of the opacifier of the liquid detergent of the invention apply mutatis mutandis to the process for making the premix and the process for making the detergent.

### DETAILED DESCRIPTION OF THE INVENTION

The present invention envisages a liquid detergent comprising a mono-alcohol and an opacifier. The detergent presents a good aesthetic profile and good stability. The invention also envisages a process for making a premix and a process for making a liquid detergent comprising the premix. The process is very robust in terms of stability of the final detergent.

### Mono-Alcohol

As stated before a “mono-alcohol” is a hydrocarbon comprising only one —OH group. Preferably, the mono-alcohol of the invention has a Hansen polarity parameter of from about 5 to about 15 (Mpa)^{1/2} and a Hansen hydrogen bonding parameter of from about 15 to about 25 (Mpa)^{1/2}. The parameters can be found in Charles Hansen's Hansen Solubility Parameters, A User's Handbook, 2^{nd} Edition from 2007.

Preferably the mono-alcohol is selected from the group consisting of C1 to C3 alcohols and mixtures thereof, more preferably the mono-alcohol is ethanol.

### Opacifiers

Opacifiers are usually inert submicron size particles that when dispersed in liquid compositions can scatter light. They impart a milky and/or creamy appearance with uniform opacity to liquids. The opacifier of the invention exhibits an improved stability in ethanol compared to Acusol OP 301. Acusol OP 301 is commercially available from the Dow Company. Preferably the opacifier of the invention is an organic based opacifier, more preferably a polymeric opacifer, and especially a polymeric opacifier wherein the polymers are synthesized through emulsion polymerisation from styrene and acrylate monomers and monomers comprising maleate.

Suitable opacifiers include those but are not limited to those commercially available from the Dow Company. Examples include Acusol OP 302 (Styrene-acrylate-divinylbenzene copolymer), Acusol OP 303 (Styrene-acrylamide copolymer) and Acusol OP 305 (Styrene/PEG-10 maleate—Nonoxynol-10 maleate/acrylate copolymer), most preferably Acusol OP 305. Opacifiers from the Opulyn series might also be suitable for the purpose of the invention. Alternatively, opacifiers could be sourced from the Cognis, Interpolymer, Omnova, Derypol, Indulor, Synthron and EOC surfactants companies.

Preferred opacifiers have a molecular weight of from 1,000 to 1,000,000, more preferably from about 2,000 to about 500,000, most preferably from about 5,000 to about 20,000 g/mol, and a particle size (weight average mean diameter) of from about 10 to about 1,000 nm, more preferably about 100 to about 750 nm, most preferably of about 150 to about 500 nm

The opacifier is preferably present at a level of from 0.001% to 3%, more preferably from 0.0025% to 2%, most preferably from 0.005 to 1% by weight of the final detergent composition.

When formulated in the water/mono-alcohol premix, the opacifier is preferably present at a level between about 1 and about 50%, preferably about 3 and about 40%, most preferably between about 5 and about 20%.

### The Liquid Detergent

The liquid detergent is suitable for hand dishwashing, heavy duty laundry, hard surface cleaning, etc. Preferably the liquid detergent is a hand dishwashing detergent. It typically contains from 30% to 95%, preferably from 40% to 90%, more preferably from 50% to 85% by weight of a liquid carrier in which the other essential and optional components are dissolved, dispersed or suspended. One preferred component of the liquid carrier is water.

Preferably the pH of the detergent is adjusted to between 3 and 14, more preferably between 4 and 13, more preferably between 6 and 12 and most preferably between 8 and 10. The pH of the detergent can be adjusted using pH modifying ingredients known in the art.

The liquid detergent herein preferably comprises a surfactant system and more preferably a number of other optional ingredients such as builders, chelants, conditioning polymers, cleaning polymers, surface modifying polymers, soil flocculating polymers, structurants, emmolients, humectants, skin rejuvenating actives, enzymes, carboxylic acids, scrubbing particles, bleach and bleach activators, perfumes, malodor control agents, pigments, dyes, additional opacifiers, beads, pearlescent particles, microcapsules, organic and inorganic cations such as alkaline earth metals such as Ca/Mg-ions and diamines, suds suppressors/stabilizers/boosters, antibacterial agents, preservatives and pH adjusters and buffering means.

The liquid detergent can comprise from about 1% to about 50%, preferably from about 5% to about 40% more preferably from about 8% to about 35% by weight thereof of a surfactant system. The surfactant system preferably comprises an alkoxylated anionic surfactant. The system can optionally comprise an amphoteric, non-ionic, zwitterionic, cationic surfactant and mixtures thereof.

Preferably, the surfactant system comprises alkyl sulfates and/or alkyl ethoxy sulfates; more preferably a combination of alkyl sulfates and/or alkyl ethoxy sulfates with a combined ethoxylation degree of less than 5, preferably less than 3, more preferably less than 2 and more than 0.5. Preferably, the composition of the present invention will further comprise amphoteric and/or zwitterionic surfactant, more preferably an amine oxide or betaine surfactant.

The most preferred surfactant system for the liquid detergent of the present invention will therefore comprise: (i) 1% to 40%, preferably 6% to 32%, more preferably 8% to 25% weight of the total composition of an anionic surfactant (2) combined with 0.01% to 20% wt, preferably from 0.2% to 15% wt, more preferably from 0.5% to 10% by weight of the composition of amphoteric and/or zwitterionic and/or nonionic surfactant, more preferably an amphoteric and even more preferred an amine oxide surfactant. It has been found that such surfactant system will provide the excellent cleaning required from a hand dishwashing detergent while being very soft and gentle to the hands.

Nonionic surfactant, when present, is comprised in a typical amount of from 0.1% to 30%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol.

The liquid detergent herein preferably comprises a surfactant system comprising an anionic, an amphoteric and a non-ionic surfactant.

### Process for Making the Detergent

In some instances late product differentiation of liquid detergent is desired. A base detergent containing of the main ingredients is made and minors are added at a later state. This facilitates the manufacture of a plurality of different products starting from the same base. Aesthetics modifications of detergents sometimes take place at the end of the manufacturing process, i.e., when the main ingredients have already been mixed. In some instances, it is desirable to make a premix that will be subsequently added to the mixture of the base. A premix of a minor ingredient can be advantageous when the level of active required is very low, this can help with accurate dosing during the manufacturing process. In some instances, anti-microbial agents need to be added in order to avoid microbial growth. Mono-alcohols present good anti-microbial properties. However, it has been found that mono-alcohols when added to opacifiers can bring instability issues, such as sedimentation and separation of the opacifier in the premix. Once the instability takes place it is very difficult to correct it later on in the process and it will bring instability to the final detergent. Thus the mixing of the premix needs to be such that a quasi perfect mixture is obtained. This requirement bring a lot of constrains to the manufacture process (increased mixing time and energy). The process of the present invention overcomes the above issues thereby improving process flexibility and efficiency.

The premix of the present invention comprises the step of mixing water, a mono-alcohol and an opacifier. Mixing can take place in any mixing vessel, the premix can be consequently stored, preferably the premix is kept under agitation in the storage tank. It has been found that mixing from about 5-10% of opacifer, in particular Acusol 305, from about 10-15% of ethanol and from about 75 to 85% of water a very stable premix is obtained.

The premix is added to a base detergent to make the finish liquid detergent.

### Stability Test

The stability of the opacifier of the invention versus the stability of Acusol 301 is compared using the method described herein below.

Solutions are made at 20° C. containing 3 parts of mono-alcohol and 1 part of Acusol (Acusol is provided in liquid form with 40% solids (as supplied by the Dow Company)). Solutions were mixed till a visually homogeneous dispersion was obtained. The solutions are stored for 12 hours at room temperature. This datapoint refers to the 100% datapoint.

Solutions with different mono-alcohol concentration were prepared in which 3 parts of mono-alcohol solvent were gradually replaced by demineralized water (not touching Acusol concentration in Acusol—solvent/water mixture) to detect the mono-alcohol concentration at which respective Acusol emulsions remain stable upon overnight storage at 20° C.

The 50% datapoint reflects half of the mono-alcohol being replaced by water, resulting in a 1.5 part water—1.5 part mono-alcohol—1 part 40% active Acusol mixture.

TABLE 1

| | | | Acusol 301 | Acusol 305 |
|---|---|---|---|---|
| | | | failure onset | failure onset |
| Alcohol | P-value | H-value | concentration | concentration |
| methanol | 12.3 | 22.3 | 65% ok, | 100% ok |
| | | | 75% fails | |
| ethanol | 8.8 | 19.4 | 35% ok, | 75% ok, |
| | | | 50% fails | 100% fails |
| 1-propanol | 6.8 | 17.4 | 25% fails | 100% ok |
| 2-propanol | 6.1 | 16.4 | 25% ok, | 100% ok |
| | | | 35% fails | |

As it can be seen from Table 1 Acusol 305 is more stable in the presence of mono-alcohols than Acusol 301.

Example of a hand dish formulation comprising Acusol 305.

TABLE 2

| Ingredient | % active weight |
|---|---|
| Alkyl C10-14 | 13.22 |
| ethoxy sulfate | |
| C12-14 dimethyl | 4.41 |
| aminoxide | |
| Non-ionic | 4.5 |
| surfactant | |
| NaCl | 1.2 |
| Polypropylene | 0.5 |
| glycol Mw 2000 | |
| NaOH | 0.15 |
| MIT | 0.0075 |
| Phenoxy ethanol | 0.15 |
| Cationic polymer | 0.1 |
| Opacifier premix | 1% |

### Opacifier Premix

TABLE 3

| | As 100% active RM | % parts |
|---|---|---|
| Acusol OP305 (40% active) | 8 | 20 |
| Ethanol | 10.61 | 11.50 |
| Water | 81.39 | 68.50 |

A detergent base is made comprising all the ingredients shown in Table 2 apart from the cationic polymer. The cationic polymer and the opacifier premix are subsequently added to the detergent base to obtain the finished product. The finished product has a very appealing opaque appearance and it is very stable.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent aqueous composition comprising a mono-alcohol and an opacifier wherein the opacifier comprises a high order polymer.

2. A liquid detergent according to claim 1 wherein the polymer comprises monomers comprising styrene.

3. A liquid detergent according to claim 1 wherein the polymer comprises monomers comprising units selected from the group consisting of carboxylates, carboxylic amides, alkenyl, alkoxy, polyalkoxy and mixtures thereof.

4. A liquid detergent according to claim 3 wherein the carboxylate is selected from acrylate, maleate and mixtures thereof.

5. A liquid detergent according to claim 1 wherein the polymer comprises monomers comprising styrene, monomers comprising maleate, and monomers comprising acrylate.

6. A liquid detergent according to claim 1 wherein the polymer is a styrene/polyethlylene glycol-10, maleate/nonoxynol-10, maleate/acrylate polymer.

7. A liquid detergent according to claim 1 comprising from about 0.001% to about 3% by weight of the composition of opacifier.

8. A liquid detergent according to claim 1 wherein the mono-alcohol has Hansen polarity parameter of from about 5 to about 15 (Mpa)^{1/2} and a Hansen hydrogen bonding parameter of from about 15 to about 25 (Mpa)^{1/2}.

9. A liquid detergent according to claim 1 wherein the mono-alcohol is selected from the group consisting of C1 to C3 alcohols and mixtures thereof.

10. A liquid detergent according to claim 1 wherein the polymer is a styrene/polyethlylene glycol-10, maleate/nonoxynol-10, maleate/acrylate polymer and the mono-alcohol is ethanol.

11. A liquid detergent according to claim 1 comprising from 0.5 to 5% by weight of the composition of mono-alcohol.

12. A process for making a premix comprising the step of mixing water, a mono-alcohol and an opacifier wherein the opacifier comprises a high order polymer.

13. A process according to claim 12 wherein the mixing step does not require homogeneous mixing.

14. A process according to claim 12 wherein the opacifier used to make the premix is in the form of an aqueous dispersion with a solid content of from 10 to 50% by weight of the dispersion.

15. A process according to claim 12 wherein the level of opacifier in the premix is from 2% to 20% by weight thereof.

16. A process according to claim 12 wherein the level of mono-alcohol is below 20% by weight of the premix.

17. A process for making a liquid detergent composition comprising the steps of adding the premix according to claim 12 to a detergent base.

18. A process according to claim 17 wherein the process is continuous.

19. A process according to claim 17 for making the liquid detergent of claims 1.
